(19) United States
(12) Patent Application Publication
(10) Pub. No.: US 2026/0185671 A1
(43) Pub. Date: Jul. 2, 2026

(54) LOW ENERGY USAGE LIGHTING DEVICE

(71) Applicant: Margik, Inc., Charlotte, NC (US)

(72) Inventors: Kevin M. Boyle, Waxhaw, NC (US); Adam W. Earnhardt, Huntersville, NC (US); Margaret Kocherga, Charlotte, NC (US); Alexander Mikhailovsky, Ventura, CA (US); Marc Sims, Santa Barbara, CA (US)

(73) Assignee: Margik, Inc., Charlotte, NC (US)

(21) Appl. No.: 19/006,045

(22) Filed: Dec. 30, 2024

(51) Int. Cl. F21S 41/19; C09J 9/02; C09J 11/04; F21S 9/02; F21S 41/155; F21S 43/145; F21S 43/19; F21V 23/00; F21W 107/17; F21Y 115/15

(52) U.S. Cl. CPC F21S 41/192; C09J 9/02; C09J 11/04; F21S 9/02; F21S 41/155; F21S 43/145; F21S 43/195; F21V 23/005; F21S 2243/00; F21W 2107/17; F21Y 2115/15

(57) ABSTRACT

In an embodiment there is a safety light that includes an OLED disposed over and in electrical communication with a circuit board, and a conductive adhesive securing the OLED to the circuit board. The OLED includes a cathode, an anode, and a light emitting layer disposed between the cathode and the anode. The circuit board includes a supporting substrate, a first conductor track disposed over a first surface of the supporting substrate, and a second conductor track disposed over a second surface of the supporting substrate. The conductive adhesive includes at least one carbon nanotube, and at least one adhesive matrix. The electrical communication includes the cathode in electrical communication with a first terminal of the first conductor track, and the anode in electrical communication with a second terminal of the first conductor track.

### BACKGROUND OF THE INVENTION

Vehicles that rely on internal combustion engines (ICEs) use alternators to convert mechanical energy to electric energy for various purposes such as to continuously recharge on-board batteries and to ensure that electrical accessories are constantly powered. This is especially important for safety lights such as headlights and taillights. Since alternators can produce electrical energy abundantly from the mechanical energy produced by fuel in the vehicle's tank, incumbent light accessories for ICEs typically use incandescents without noticeable drainage. It is well known, however, that incandescent light sources do not consume energy efficiently and generate heat, so they are not considered suitable for electric automotives that do not contain alternators and whose range relies on total battery capacity. Additionally electric vehicle designs omit the traditional ventilation systems of ICEs, thus the generated heat of lights is much more of a problem.

Furthermore, a high peel strength adhesive can be desirable for applications where resistance to vibrations is important, such as in automotives. High peel strength indicates that the adhesive can withstand significant force perpendicular to the joint without detaching. This characteristic is crucial in environments subjected to vibrations, as it helps ensure that the bond remains intact under dynamic stress. For example, adhesives with a high peel strength of are used for body panel bonding and exterior applications in order to cope with aerodynamic forces, vibrations and temperature variations, while those with even higher peel strengths are used to bond chassis parts or frame components. However, it is noteworthy that the integrity of an electrical contact does not necessarily correspond well to the mechanical strength of a bond. Indeed, there are instances of electrical contact failure in the absence of any obvious mechanical failure. There are likely other, more subtle factors at play which contribute to the failure of electrical contacts during vibrational stress. What is needed, therefore, are conductive adhesives with more elevated peel strength values to increase the likelihood of robust and long-lived electrical contacts and moreover, to avoid anisotropic conductive films (ACFs), electrically conductive double-sided tapes and electrically conductive transfer tapes/adhesives which typically have peel strength values below 15 N/cm (on steel), for improved light technology that may be integrated into a wide range of applications, including vehicles, such as electric vehicles.

### SUMMARY OF THE INVENTION

In an embodiment there is a safety light. The safety light includes an OLED disposed over and in electrical communication with a circuit board, and a conductive adhesive securing the OLED to the circuit board. The OLED includes a cathode, an anode, and a light emitting layer disposed between the cathode and the anode. The circuit board includes a supporting substrate, a first conductor track disposed over a first surface of the supporting substrate, and a second conductor track disposed over a second surface of the supporting substrate. The conductive adhesive includes at least one carbon nanotube, and at least one adhesive matrix in which the at least one carbon nanotube is dispersed. The electrical communication includes the cathode in electrical communication with a first terminal of the first conductor track, and the anode in electrical communication with a second terminal of the first conductor track.

In another embodiment, there is a method for forming a safety light. The method includes providing an OLED disposed over and in electrical communication with a circuit board. The method includes securing, with a conductive adhesive, the OLED to the circuit board. The OLED includes a cathode, an anode, and a light emitting layer disposed between the cathode and the anode. The circuit board includes a supporting substrate, a first conductor track disposed over a first surface of the supporting substrate, and a second conductor track disposed over a second surface of the supporting substrate. The conductive adhesive includes at least one carbon nanotube and at least one adhesive matrix in which the at least one carbon nanotube is dispersed. The electrical communication includes the cathode in electrical communication with a first terminal of the first conductor track, and the anode in electrical communication with a second terminal of the first conductor track.

In another embodiment, there is an electric vehicle. The electric vehicle includes a vehicle body, and at least one safety light secured to the vehicle body. The at least one safety light includes an OLED disposed over and in electrical communication with a circuit board, and a conductive adhesive securing the OLED to the circuit board. The OLED includes a cathode, an anode, and a light emitting layer disposed between the cathode and the anode. The circuit board includes a supporting substrate, a first conductor track disposed over a first surface of the supporting substrate, and a second conductor track disposed over a second surface of the supporting substrate. The conductive adhesive includes at least one carbon nanotube, and at least one adhesive matrix in which the at least one carbon nanotube is dispersed. The electrical communication includes the cathode in electrical communication with the first conductor track, and the anode in electrical communication with the second conductor track.

### BRIEF DESCRIPTION OF DRAWINGS

FIG. 1 is a cross-sectional view of a safety light.

FIG. 2 is a simplified circuit diagram showing the safety light of FIG. 1 in electrical communication with a sensing and control unit as well as a battery.

FIG. 3A is a flow chart describing a method for forming a safety light.

FIG. 3B is a flow chart describing an additional step in the method described in the flow chart of FIG. 3A.

FIG. 3C is a flow chart describing an additional step in the method described in the flow chart of FIG. 3A.

FIGS. 4A-4D depict various cross-sectional views corresponding to steps of a method of forming a safety light in which a power source is secured to be disposed over and in electrical communication with a circuit board after an OLED is secured to the circuit board.

FIGS. 5A-5D depict various cross-sectional views corresponding to steps of a method of forming a safety light in which a power source is secured to be disposed over and in electrical communication with a circuit board before an OLED is secured to the circuit board.

FIG. 6 illustrates an electric vehicle of an embodiment.

### DETAILED DESCRIPTION OF THE INVENTION

OLEDs and LEDs can be significantly more energy efficient and generate considerably less heat than incandescent light sources and can, therefore, significantly reduce the fraction of battery power that is allocated to safety lights. In certain circumstances, the use of OLEDs and LEDs can enhance the range that is achievable on a single battery charge. This is especially true for lightweight, low power electric automotives. Described herein are embodiments of inventive conductive adhesives and embodiments of inventive methods for producing such inventive conductive adhesives, as well as embodiments of safety lights that comprise such conductive adhesives and embodiments of methods for producing such safety lights. While not limited to any particular benefit, the embodiments described herein provide conductive adhesives having electrical integrity under high dynamic stress and extreme environmental conditions.

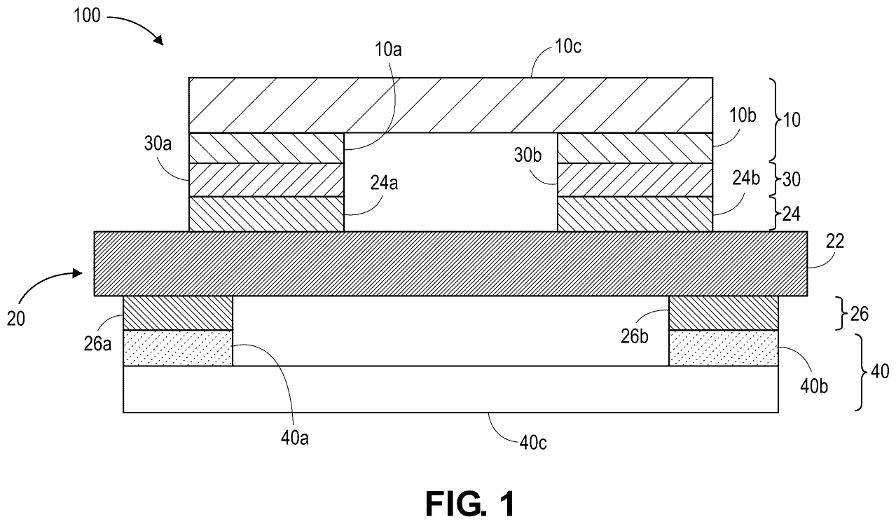

A safety light 100 is shown in FIG. 1. The safety light 100 includes an OLED 10 having an anode 10a, a cathode 10b, and additional structure(s) 10c including a light emitting layer, the OLED 10 disposed over and in electrical communication with a circuit board 20, and a conductive adhesive 30 disposed at a first portion 30a and a second portion 30b, the conductive adhesive 30 securing the OLED 10 to the circuit board 20. The circuit board 20 includes a supporting substrate 22, a first conductor track 24 having a first terminal 24a and a second terminal 24b, with the first conductor track 24 disposed over a first surface of the supporting substrate 22, and a second conductor track 26 having a first terminal 26a and a second terminal 26b, with the second conductor track 26 disposed over a second surface of the supporting substrate 20.

The conductive adhesive 30 may be disposed between the OLED 10 and the first conductor track 24. As such the conductive adhesive both attaches the OLED 10 to the circuit board 20 and provides electrical connectivity between the OLED 10 and at least the first conductor track 24. For example, as shown in FIG. 1, the conductive adhesive 30 is disposed between the OLED 10 and the first conductor track 24. More specifically, the first portion 30a of conductive adhesive 30 may be disposed between the anode 10a of OLED 10 and the first terminal 24a of first conductor track 24, and/or the second portion 30b of conductive adhesive 30 may be disposed between the cathode 10b of OLED 10 and the second terminal 24b of first conductor track 24, such as illustrated in FIG. 1.

The safety light may further comprise a power source, such as a battery disposed over and in electrical communication with the circuit board. In some embodiments, the safety light may be directly connected to an external battery rather than to a battery disposed over the circuit board. For example, a safety light of an embodiment is provided as a lightweight, low-power electrical component of a vehicle, wherein the safety light is directly connected to the vehicle's battery. In an embodiment, to form an electrical communication between the vehicle's battery and the safety light, a wired connection from the vehicle's battery may be soldered to corresponding terminals over the circuit board over which the safety light is attached.

For example, as shown in FIG. 1, the safety light 100 comprises a battery 40 having an anode 40a, a cathode 40b, and additional structure(s) 40c including charge storage and/or electrolyte layers disposed between the anode 40a and cathode 40b, with the battery 40 disposed over and in electrical communication with the circuit board 20.

In an embodiment, the battery may be secured to the second conductor track. As shown in FIG. 1, the battery 40 is secured to the second conductor track 26. More specifically, anode 40a of battery 40 may be in electrical communication with the first terminal 26a of second conductor track 26, and/or the cathode 40b of battery 40 may be un electrical communication with second terminal 26b of second conductor track 26, such as illustrated in FIG. 1.

The OLED may include an encapsulated OLED. The OLED may include a cathode, an anode and additional structure(s) including a light emitting layer (also described herein as an “emissive layer”). The OLED may be a top-emissive OLED or a bottom-emissive OLED. The OLED 10 in FIG. 1 includes an anode 10a, a cathode 10b and additional structure(s) 10c including a light emitting layer which may be disposed between the cathode and the anode. The anode may comprise a transparent anode such as a transparent conductive oxide and the cathode may comprise a metal such as aluminum. The OLED 10 is electrically and mechanically connected to a circuit board 20 such as a printed circuit board (PCB). Connection of the OLED to the PCB is facilitated by a conductive adhesive according to an embodiment described herein, such as conductive adhesive 30. While such is described in more detail below, briefly, the adhesive is dispersed over terminals (e.g., first conductor track 24, such as at first terminal 24a and second terminal 24b) of the PCB to secure the OLED in place while also forming an electric connection.

Additional structures may be included in the safety light. For example, after securing the OLED 10 to circuit board 20, additional structures may be included in the safety light 100 including, but not limited to, at least one of the following: one or more filters, one or more encapsulants, one or more blending/scattering layer. In addition to or separately from the inclusion of additional structures, the OLED may be modified, including via the inclusion of a roughened texture on a surface thereof such as a diffuser layer. While not limited to any particular theory, it is believed that such modifications improve output light intensity to be more evenly distributed and could shift the white point in white light devices and also intensify, improve the color purity, and homogenize the optical output of red light devices.

The OLED may be selected from commercially available sources. For example, the OLED may be, but not limited to, model nos. A94FC00 or AD1RC00 (available from Konica Minolta, see, e.g., https://www.mouser.com/new/konica-minolta/konica-minolta-oled-lighting-panels/). The OLED may be selected based on appropriate beneficial properties specific to automotive uses that may not be apparent, such as the reflective nature of some OLEDs to the human eye. For example, such reflective property is beneficial in safety lighting as external lighting allows viewers to see the safety light without it being energized. Further, as discussed above, the OLED—including commercially sourced OLED—may be modified to include features not available commercially such as via the addition of an optional overlayer (also referred to herein as an encapsulant) that encapsulates all of the electronic components to protect the device from the environment. Such an optional overlayer may be formed of a primer followed by a 2-part silicone formulation such as RTV615 available from Momentive Performance Materials Inc. (see, e.g., https://mgchemicals.com/products/potting-compounds/silicone-rubber/clear-rtv-silicone/) that is thermally cured at 80° C. for several hours in air.

The electrical communication between the circuit board 20 and the OLED 10 includes the anode 10a in electrical communication with a first terminal 24a of the first conductor track 24, and the cathode 10b in electrical communication with a second terminal 24b of the first conductor track 24.

The conductive adhesive 30 includes at least one carbon nanotube, and at least one adhesive matrix. In an embodiment, the at least one carbon nanotube comprises at least one single-walled carbon nanotube. In an embodiment, the at least one carbon nanotube comprises at least one multi-walled carbon nanotube. In an embodiment, the at least one carbon nanotube comprises a plurality of carbon nanotubes. In an embodiment, the at least one carbon nanotube comprises at least one single-walled carbon nanotube and at least one multi-walled carbon nanotube.

The adhesive matrix may serve as a matrix in which the at least one carbon nanotube is disposed. For example, the at least one carbon nanotube may be dispersed in the adhesive matrix. The at least one carbon nanotube may include a plurality of carbon nanotubes. The plurality of carbon nanotubes may be uniformly dispersed in the adhesive matrix.

In an embodiment there is a method for dispersing at least one carbon nanotube in an adhesive matrix comprising a two-part epoxy: The at least one carbon nanotube is dispersed in two steps. In the first step the at least one carbon nanotube is added to a first stage of the two-part epoxy and stirred, for example, at about 7-15 m/s for about 20 minutes. In the second step, a second part of the two-part epoxy is added to the mixture comprising the first epoxy and the at least one carbon nanotube, followed by stirring at about 7-15 m/s for about 5 minutes. The two-part epoxy is cured at ambient temperature, pressure, humidity and atmosphere.

In an embodiment, there is a method for dispersing at least one carbon nanotube in an adhesive matrix comprising a heat-cured epoxy. The at least one carbon nanotube is mixed with a heat-cured epoxy and stirred at about 7-15 m/s for about 25 minutes, then the mixture is heated to the appropriate curing temperature for the designated amount of time to cure the epoxy.

In an embodiment, the conductive adhesive comprises 1-20% by weight of the at least one carbon nanotube. In an embodiment, the conductive adhesive comprises 5-15% by weight of the at least one carbon nanotube. In an embodiment, the conductive adhesive comprises 10-12.5% by weight of the at least one carbon nanotube. In an embodiment, the conductive adhesive comprises 1-5% by weight of the at least one carbon nanotube.

In an embodiment, the conductive adhesive comprises a contact resistance of from about 0.1Ω to about 1.5Ω. While not limited to a particular theory, it is believed that the addition of conductive media (e.g., at least one carbon nanotubes or other nanostructured carbon, and/or at least one of a conductive metal nanoparticles) with a matrix material such as an adhesive (e.g., epoxy) may provide contact resistance at a desired value. For example, during processing of the adhesive of the embodiments, conductive media with the adhesive matrix to create a uniform dispersion. It is further believed that a uniform dispersion of the conductive media in the adhesive matrix provides for uniform conductive and adhesive properties in the resulting conductive adhesive itself.

Peel strength is an important property of the conductive adhesive and is necessary for adhering the OLED to the conductor track as described above. Because the safety light of the embodiments during operation will experience stresses that would cause lower peel-strength adhesive or conductive tape to fail, embodiments described herein utilize a high peel-strength adhesive, such as an epoxy, having higher peel strengths that may be an order of magnitude greater than low peel-strength adhesives and conductive tapes. Accordingly, in an embodiment, the conductive adhesive described herein comprises a peel strength of from about 15 N/cm to about 195 N/cm, for example from about 18 N/cm to about 195 N/cm, wherein such peel strength is determined under conditions set forth according to the Standard Test Method for Floating Roller Peel Resistance of Adhesives (ASTM D3167-10) (hereinafter, the “Floating Roller Peel Test”).

The operating temperature range is a property of, among other things, the adhesive matrix (e.g., epoxy) itself and is dependent on which adhesive matrix material is used, and the operating temperature of the adhesive matrix is important due to changes in strength and adhesive properties at extreme environmental temperatures. For example, an improper adhesive with a small operating temperature range will prematurely fail during normal operation. Thus, while soldered contacts are in general far better for forming an electrical and mechanical connection between an OLED and PCB, the temperature required to create a soldered joint is too high for the OLED. Further, even heat cured epoxies are limiting for use in conductive adhesives because curing temperatures thereof far exceed the operating temperature of the OLEDs. Thus, thermal curing temperatures should be as low as possible, for example, no higher than 85° C. In an embodiment, the epoxy may be curable at room temperature.

In an embodiment, the conductive adhesive comprises an operating temperature of from −80° C. to about 230° C. In an embodiment, the conductive adhesive comprises an operating temperature of from −80° C. to about 150° C. In an embodiment, the conductive adhesive comprises an operating temperature of from −55° C. to about 230° C.

The conductive adhesive may have a thickness in the range of from about 1 μm to about 500 μm, for example from about 1 μm to about 250 μm including from about 1 μm to about 100 μm such as from about 1 μm to about 503 μm micrometers.

The conductive adhesive may comprise a shear strength of from about 4 MPa to about 40 MPa, such as from about 10 MPa to about 38 MPa, including from about 15 MPa to about 35 MPa, wherein such shear strength is determined under conditions set forth according to the Standard Test Method for Apparent Shear Strength of Single-Lap-Joint Adhesively Bonded Metal Specimens by Tension Loading (Metal-toMetal) (ASTM D1002-10).

In an embodiment, the adhesive matrix may be formed from a two-stage resin comprising a first resin and a second resin. In an embodiment, the conductive adhesive may be formed by dispersing the at least one carbon nanotube in the first resin to form a first mixture and subsequently forming a second mixture by adding the second resin to the first mixture.

Suitable adhesive matrix materials for use in the conductive adhesive include commercially available structural adhesives such as those available from, for example, the 3M Company. For example, suitable adhesive matrix material(s) may include one or more selected from, but not limited to 3M Scotch-Weld Flexible Epoxies Nos. DP100 Plus (Clear), DP105 (Clear), DP110 (Gray), DP110 (Translucent), DP125 (Gray), DP125 (Translucent), DP190 (Translucent), DP190 (Gray), 2216 B/A (Translucent), 2216NS B/A (Tan), 2216 B/A (Gray), 7838 B/A (Tan); 3M Scotch-Weld Toughened Epoxies Nos. DP405 (Black), DP410 (Off-White), DP410 (Black), DP420 (Black), DP420 (Off-White), DP420LH (Off-White), DP420NS (Black), DP460 (Black), DP460 (Off-White), DP460NS (Off-White), LSB60 (Gray), LSB60NS (Gray), LSB360NS (Green), DP490 (Black), DP760 (White), 7240 FR (Black), 7260 FC (Gray), 7260 NS (Gray), 7260 FC NS (Gray); 3M Scotch-Weld Heat-Cured Epoxy No. 1386 (Cream); 3M Scotch-Weld Standard MMA Acrylics No. DP8425NS (Green), DP8407NS (Green), DP8410NS (Green), DP8405NS (Green); 3M Scotch-Weld Low Odor Acrylics No. DP8825NS (Green), DP8805NS (Green), DP8810NS (Green), DP8810NS (Gray), DP8705NS (Black), DP8710NS (Black), DP8725NS (Black), DP810 (Tan), DP810NS (Tan), DP810 (Black); 3M Scotch-Weld Flexible Acrylics No. DP8610NS (Black), DP8625NS (Black), DP8625NS (Grey); 3M Scotch-Weld Semi-Rigid Urethanes No. DP6330NS (Green); and 3M Scotch-Weld Flexible Urethanes No. DP620NS (Black), DP640 (Brown), 3549 (Brown), DP604NS (Black), DP610 (Clear). Henkel Loctite Structural Adhesives Nos. AA 332, AA 334, AA H3000, AA H3151, AA 3000, AA H3410, AA 3412, HY 4080, AA H4500, AA H4800, AA 8000, AA H8003, AA 8010, AA H8100, AA H8500, AA H8600, AA H8610, EA 9461; Henkel Teroson Structural Adhesives No. EP 5055SB. In a specific embodiment, the adhesive matrix material comprises 3M Scotch-Weld Flexible Epoxy No. DP190 (Translucent).

Suitable conductive materials for use in the conductive adhesive of the embodiments include single and/or multi-walled carbon nanotubes such as those available from OcSiAl USA under the brand name TUBALL™, including but not limited to, Matrix 201, Matrix 202, Matrix 203, Matrix 204, Matrix 207, Matrix 208, Matrix 209, Matrix 301, Matrix 302. Preferably, single-walled carbon nanotubes that are suitable for use in the conductive adhesive without affecting the viscosity of the corresponding adhesive matrix material provide for a much simpler manufacturing process in a method of making a conductive adhesive of the embodiments. Accordingly, in an embodiment, the conductive adhesive includes Matrix 207 and/or Matrix 301 carbon nanotubes.

In an embodiment, the conductive adhesive comprises at least one nanomaterial selected from the group consisting of nanoparticles, nanowires, nanorods, nanosheets and nanoribbons. In an embodiment, the conductive adhesive comprises at least one metal selected from the group consisting of copper, silver, gold, nickel, palladium, and platinum, which are known for their advantageous thermal and electrical conductivities. The aforementioned metals are doped as metal nanoparticles into the adhesive matrix at between about 0.01% and 0.5% by weight. Preferably the metal nanoparticles can range in size between 5 nm and 250 nm.

In an embodiment, the conductive adhesive comprises graphene. In an embodiment, the conductive adhesive comprises 1-20% by weight of graphene. In an embodiment, the conductive adhesive comprises 5-15% by weight of graphene. In an embodiment, the conductive adhesive comprises 10-12.5% by weight of graphene. In an embodiment, the conductive adhesive comprises 1-5% by weight of graphene.

Peel strength testing of several conventional adhesives and the inventive adhesive composition was performed according to the Floating Roller Peel Test. Table 1 shows the resulting measured peel strengths:

| Adhesive Identifier | Peel Strength (N/cm) |
|---|---|
| Conventional Adhesive 1 | 2.8 |
| Conventional Adhesive 2 | 3.3 |
| Conventional Adhesive 3 | 6.9 |
| Conventional Adhesive 4 | 12 |
| Inventive Conductive Adhesive 1 | 42 |
| Inventive Conductive Adhesive 2 | 49 |

As shown in Table 1, the conventional adhesives nos. 1-4 have peel strength under 15 N/cm while the inventive conductive adhesive nos. 1-2 have peel strengths of generally equal to or greater than 15 N/cm, more specifically in the range of from about 15 N/cm to about 195 N/cm, including from about 18 N/cm to about 195 N/cm, as measured via the Floating Roller Peel Test.

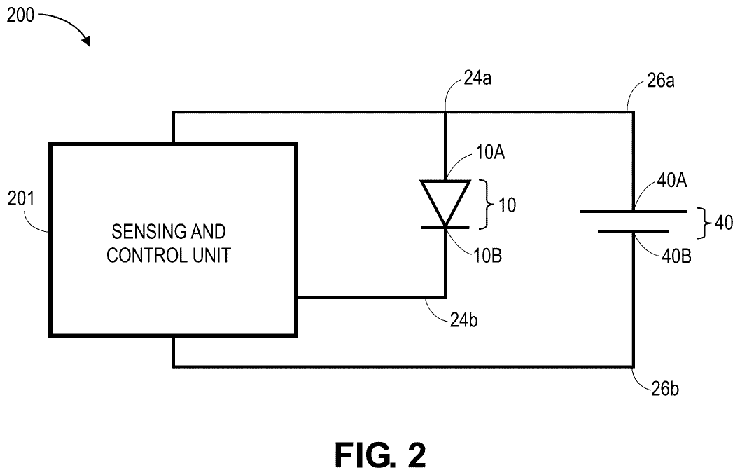

As further shown in FIG. 1 and as discussed above, the safety light of the embodiments may include a circuit board 20 to support the OLED 10 and battery 40. In an embodiment, circuit board 20 is provided as a printed circuit board (PCB) which includes substrate 22 supporting a first conductor track 24 and second conductor track 26. As further shown in the circuit diagram 200 of FIG. 2, a sensing and control unit 201 may be in electrical communication with both the OLED 10 and battery 40 via first and second conductor tracks. For example, first terminal 24a of the first conductor track is in electrical communication with OLED 10 via anode 10a and first terminal 26a of the second conductor track is in electrical communication with battery 40 via anode 40a, while second terminal 24b of the first conductor track is in electrical communication with OLED 10 via cathode 10b and second terminal 26b of the second conductor track is in electrical communication with battery 40 via cathode 40b.

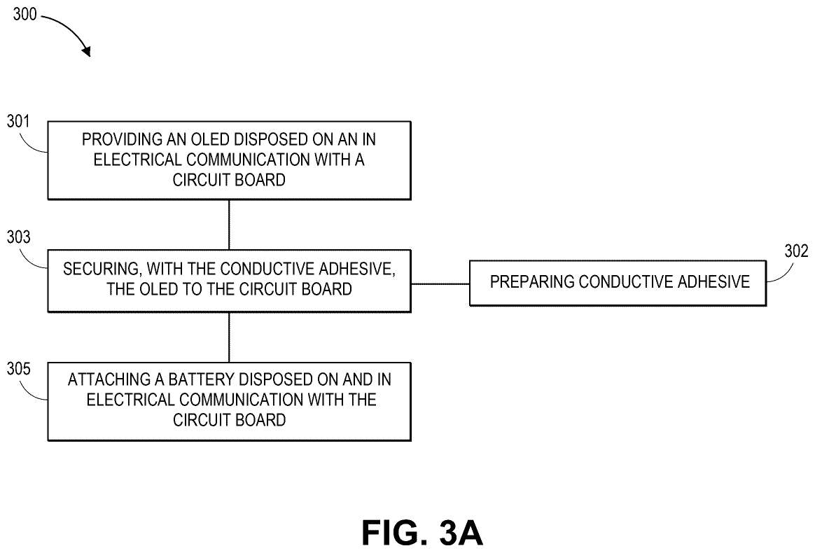

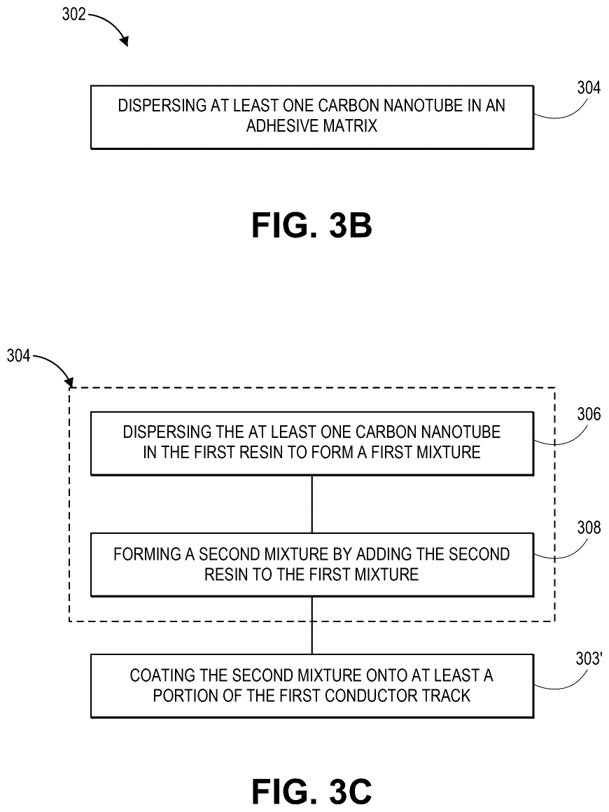

As illustrated in the flow charts of FIGS. 3A-3C, in an embodiment, there is a method 300 for forming a safety light. The method includes 301 providing an OLED disposed over and in electrical communication with a circuit board. The method includes 303 securing, with a conductive adhesive, the OLED to the circuit board. The method includes 305 attaching a battery disposed over and in electrical communication with the circuit board.

In an embodiment, the OLED includes a cathode, an anode, and a light emitting layer disposed between the cathode and the anode. The circuit board includes a supporting substrate, a first conductor track disposed over a first surface of the supporting substrate, and a second conductor track disposed over a second surface of the supporting substrate. The conductive adhesive includes at least one carbon nanotube and at least one adhesive matrix material. In an embodiment, the conductive adhesive further comprises at least one selected from the group consisting of copper, silver, gold, nickel, palladium, and platinum. The electrical communication includes the cathode in electrical communication with a first terminal of the first conductor track, and the anode in electrical communication with a second terminal of the first conductor track.

In an embodiment, the method for forming a safety light may further comprise 302 preparing the conductive adhesive. In an embodiment, the 302 preparing of the conductive adhesive may comprise 304 dispersing the at least one carbon nanotube in an adhesive matrix. In an embodiment, the adhesive matrix may comprise a 2-stage resin. The 2-stage resin may comprise a first resin and a second resin.

In an embodiment, the 304 dispersing of the at least one carbon nanotube dispersed in the adhesive matrix may comprise 306 dispersing the at least one carbon nanotube in the first resin to form a first mixture and 308 forming a second mixture by adding the second resin to the first mixture. In an embodiment, the dispersing of the at least one carbon nanotube in the first resin to form a first mixture, and/or the forming of the second mixture by adding the second resin to the first mixture may be performed at room temperature and ambient pressure.

In an embodiment, the conductive adhesive is disposed between the OLED and the first conductor track. Accordingly, in an embodiment, the method for forming a safety light may further comprise 303′ coating the second mixture onto at least a portion of the first conductor track.

While not limited to any particular method, the depositing may be performed via spin deposition, spin blade, 3D printing, inkjet printing or any other suitable technology now available or developed in the future. Additionally, because polymerization is exothermic, the second mixture must be deposited quickly to avoid excessive curing prior to attachment of the OLED.

In an embodiment of the method for forming a safety light, the providing of the OLED to the circuit board comprises pressing the OLED at a predetermined pressure onto the at least the portion of the first conductor track coated with the second mixture. The pressing of the OLED onto the at least the portion of the first conductor track coated with the second mixture may be performed at a pressure in the range of from about 1 MPa to about 5 MPa, for example, to form a good electrical connection between the conductive adhesive and the substrate (i.e., conductor track).

In an embodiment of the method for forming a safety light, the securing, with the conductive adhesive, of the OLED to the circuit board comprises curing the second mixture.

The curing process depends on which material is used for the adhesive matrix. When using a two-part epoxy for the adhesive matrix, curing is performed at room temperature and pressure, humidity and atmosphere. On the other hand, when using a heat cured epoxy for the adhesive matrix, such epoxy is heated to the necessary temperature and for a predetermined time to complete the curing process.

In an embodiment of the method for forming a safety light, the method further comprises attaching a battery such that it is disposed over and in electrical communication with the circuit board. In an embodiment, the attaching of the battery comprises securing the battery to the second conductor track. In an embodiment, the securing comprises soldering the battery to the second conductor track.

Although it is undesirable to do any soldering of components, such as soldering of the battery to the circuit board, after OLEDs are connected, this order of operations allows for ease of production as it mitigates the risk of there being inadvertent shorts which could damage elements of the circuit and even cause injury. However, the tradeoff is that such increases the amount of time for quality assurance. Accordingly, in an embodiment of the method for forming a safety light, the securing of the battery is performed after the securing of the OLED to the circuit board.

In an embodiment, the securing of the battery is performed prior to the securing of the OLED to the circuit board. While this takes a little more preparation time, quality and connection validation is easier. For example, in embodiments described herein, current limiting resistors can be included in the printed circuit board to limit current flow in the circuit should there be any inadvertent locations where a short could form after securing the battery. In embodiments, a switch is provided in the circuit board that can be set to the “off” position during assembly.

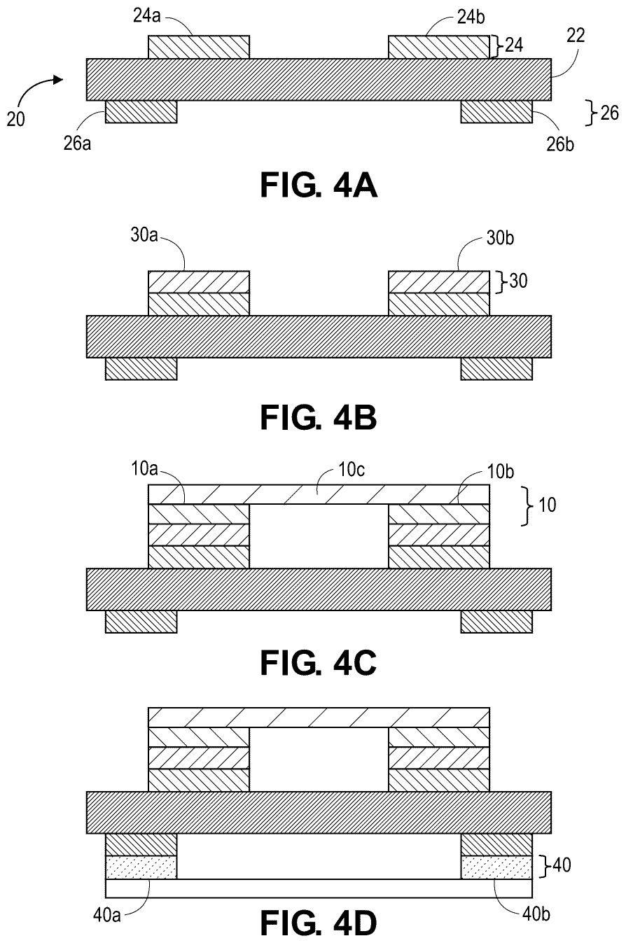

As shown in FIGS. 4A-4D, a method for forming a safety light according to an embodiment is depicted via various cross-sectional views during the fabrication of a safety light. As shown therein, a power source such as a battery 40 is secured so as to be disposed over and in electrical communication with a circuit board 20. As depicted at FIGS. 4C-4D, the power source such as battery 40 is secured to the circuit board 20 after OLED 10 is secured to the circuit board 20. For example, at FIG. 4A the printed circuit board 20 is provided, and the printed circuit board 20 comprises first conductor track 24 and second conductor track 26 both disposed over substrate 22. At FIG. 4B, the conductive adhesive 30 is then deposited onto the first conductor track 24. At FIG. 4C, the OLED 10 is secured to and placed in electrical communication with circuit board 20 via the conductive adhesive 30. At FIG. 4D, a power source, such as battery 40, is then secured to and placed in electrical communication with the circuit board 20, such as at second conductor track 26.

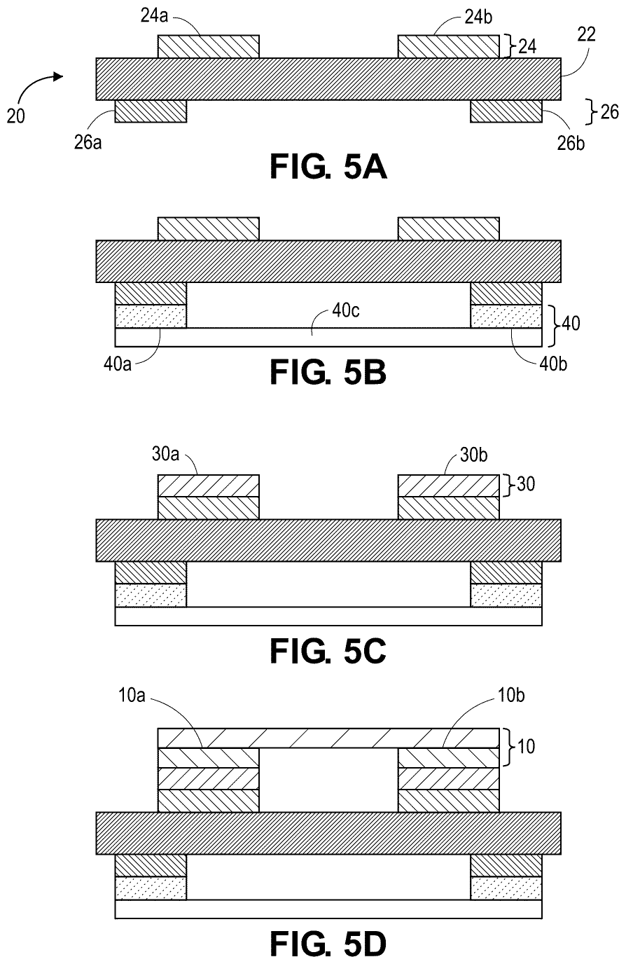

As shown in FIGS. 5A-5D, a method for forming a safety light is depicted via various cross-sectional views during the fabrication of a safety light. As shown therein, a power source such as a battery 40 is secured so as to be disposed over and in electrical communication with a circuit board 20. As depicted at FIGS. 5B-5C, the power source such as battery 40 is secured to the circuit board 20 before an OLED 10 is secured to the circuit board. For example, at FIG. 5A the printed circuit board 20 is provided, and the circuit board 20 comprises first conductor track 24 (having first terminal 24a and second terminal 24b) and second conductor track 26 (having first terminal 26a and second terminal 26b) disposed over substrate 22. At FIG. 5B, a power source, such as battery 40, is then secured to and placed in electrical communication with the circuit board 20, such as at the second conductor track 26. At FIG. 5C, the conductive adhesive 30 is then deposited onto the first conductor track 24. At FIG. 5D, the OLED 10 is secured to and placed in electrical communication with circuit board 20 via the conductive adhesive 30.

While spot welding of the battery onto the circuit board can be performed at any time, the risk of damaging an already secured OLED remains. Accordingly, spot welding batteries onto the circuit board prior to attachment of the OLED decreases the risk of OLED mechanical damage during the welding step, especially because such may occur under pressure as electrodes are pressed hard to the opposite side of the board. Indeed, thermal effects of spot welding are minimal because the heat is applied locally and for a short period of time.

In another embodiment, there is an electric vehicle. The electric vehicle includes a vehicle body, and at least one safety light secured to the vehicle body. The at least one safety light includes an OLED disposed over and in electrical communication with a circuit board, and a conductive adhesive securing the OLED to the circuit board. The OLED includes a cathode, an anode, and a light emitting layer disposed between the cathode and the anode. The circuit board includes a supporting substrate, a first conductor track disposed over a first surface of the supporting substrate, and a second conductor track disposed over a second surface of the supporting substrate. The conductive adhesive includes at least one carbon nanotube, and at least one adhesive matrix. The electrical communication includes the cathode in electrical communication with a first terminal of the first conductor track, and the anode in electrical communication with a second terminal of the first conductor track.

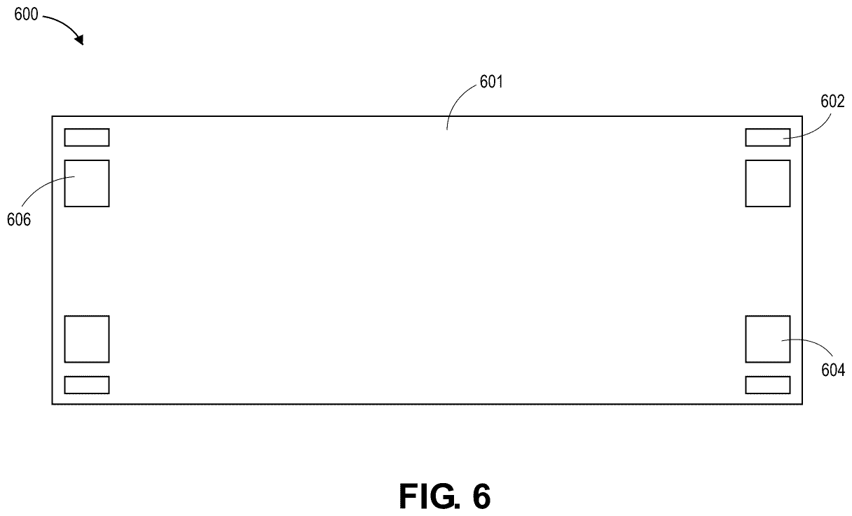

For example, as shown in FIG. 6, an electric vehicle 600 includes a vehicle body 601, and at least one safety light secured to the vehicle body. In an embodiment, the at least one safety light comprises a turn signal 602 disposed over a side of the vehicle body 601. In an embodiment, the at least one safety light comprises a brake light 604 disposed over a rear of the vehicle body 601. In an embodiment, the at least one safety light comprises a running light 606 adapted to remain illuminated during vehicle operation.

While not limited to any particular vehicle, the electric vehicle of the embodiments may be, but is not limited to, an electric motorcycle, scooter, bicycle, unicycle, skateboard, ONEWHEEL™, all-terrain vehicle, drone, passenger or commercial car, van, bus, caravan, boat and recreational vehicle (RV).

In summary, various examples are disclosed herein, including but not limited to the following numbered examples:

Example 1: A safety light, comprising:
an OLED disposed over and in electrical communication with a circuit board; and
a conductive adhesive securing the OLED to the circuit board,
wherein the OLED comprises:
   a cathode,
   an anode, and
   a light emitting layer disposed between the cathode and the anode,
wherein the circuit board comprises:
   a supporting substrate,
      a first conductor track disposed over a first surface of the supporting substrate, and
      a second conductor track disposed over a second surface of the supporting substrate,
wherein the conductive adhesive comprises:
   at least one carbon nanotube, and
   at least one adhesive matrix, and
wherein the electrical communication comprises:
   the cathode in electrical communication with a first terminal of the first conductor track, and
   the anode in electrical communication with a second terminal of the first conductor track.

Example 2: The safety light of Example 1, wherein the at least one carbon nanotube comprises at least one single-walled carbon nanotube.

Example 3: The safety light of Example 1, wherein the at least one carbon nanotube comprises at least one multi-walled carbon nanotube.

Example 4: The safety light of Example 1, wherein the at least one carbon nanotube comprises a plurality of carbon nanotubes.

Example 5: The safety light of Example 4, wherein the at least one carbon nanotube comprises at least one single-walled carbon nanotube and at least one multi-walled carbon nanotube.

Example 6: The safety light of Example 1, wherein the conductive adhesive comprises 1-20% by weight of the at least one carbon nanotube.

Example 7: The safety light of Example 1, wherein the conductive adhesive comprises 5-15% by weight of the at least one carbon nanotube.

Example 8: The safety light of Example 1, wherein the conductive adhesive comprises 10-12.5% by weight of the at least one carbon nanotube.

Example 9: The safety light of Example 1, wherein the conductive adhesive comprises 1-5% by weight of the at least one carbon nanotube.

Example 10: The safety light of Example 1, wherein the conductive adhesive comprises a contact resistance of from about 0.1Ω to about 1.5Ω.

Example 11: The safety light of Example 1, wherein the conductive adhesive comprises a peel strength of from about 15 N/cm to about 195 N/cm.

Example 12: The safety light of Example 1, wherein the adhesive matrix is formed from a two-stage resin comprising a first resin and a second resin, and wherein the conductive adhesive is formed by dispersing the at least one carbon nanotube in the first resin to form a first mixture and subsequently forming a second mixture by adding the second resin to the first mixture.

Example 13: The safety light of Example 1, wherein the conductive adhesive is disposed between the OLED and the first conductor track.

Example 14: The safety light of Example 1, further comprising a battery disposed over and in electrical communication with the circuit board.

Example 15: The safety light of Example 14, wherein the battery is secured to the second conductor track.

Example 16: The safety light of Example 1, wherein the conductive adhesive further comprises graphene.

Example 17: The safety light of Example 1, wherein the conductive adhesive further comprises at least one nanomaterial selected from the group consisting of nanoparticles, nanowires, nanorods, nanosheets and nanoribbons.

Example 18: The safety light of Example 1, wherein the conductive adhesive further comprises at least one metal selected from the group consisting of copper, silver, gold, nickel, palladium, and platinum.

Example 19: The safety light of Example 18, wherein the at least one metal comprises metal nanoparticles, metal nanowires, metal nanorods, metal nanosheets, metal nanoribbons, or a combination thereof.

Example 20: The safety light of Example 1, wherein the conductive adhesive is disposed with a thickness of from about 1 μm to about 500 μm.

Example 21: A method for forming a safety light, comprising:
providing an OLED disposed over and in electrical communication with a circuit board; and
securing, with a conductive adhesive, the OLED to the circuit board,
wherein the OLED comprises:
   a cathode,
   an anode, and
   a light emitting layer disposed between the cathode and the anode,
wherein the circuit board comprises:
   a supporting substrate,
   a first conductor track disposed over a first surface of the supporting substrate, and
   a second conductor track disposed over a second surface of the supporting substrate,
wherein the conductive adhesive comprises:
   at least one carbon nanotube, and
   at least one adhesive matrix, and
wherein the electrical communication comprises:
   the cathode in electrical communication with a first terminal of the first conductor track, and
   the anode in electrical communication with a second terminal of the first conductor track.

Example 22: The method of Example 21, further comprising preparing the conductive adhesive, wherein the preparing of the conductive adhesive comprises dispersing the at least one carbon nanotube in an adhesive matrix.

Example 23: The method of Example 22, wherein the adhesive matrix comprises a 2-stage resin comprising a first resin and a second resin.

Example 24: The method of Example 22, wherein the dispersing the at least one carbon nanotube in the adhesive matrix comprises dispersing the at least one carbon nanotube in the first resin to form a first mixture and subsequently forming a second mixture by adding the second resin to the first mixture.

Example 25: The method of Example 24, further comprising coating the second mixture onto at least a portion of the first conductor track.

Example 26: The method of Example 25, wherein the providing the OLED to the circuit board comprises pressing the OLED onto the at least the portion of the first conductor track coated with the second mixture.

Example 27: The method of Example 26, wherein the securing comprises curing the second mixture.

Example 28: The method of Example 21, further comprising attaching a battery disposed over and in electrical communication with the circuit board.

Example 29: The method of Example 28, wherein the attaching the battery comprises securing the battery to the second conductor track.

Example 30: The method of Example 28, wherein the securing comprises soldering the battery to the second conductor track.

Example 31: The method of Example 28, wherein the securing of the battery is prior to the securing of the OLED to the circuit board.

Example 32: The method of Example 28, wherein the securing of the battery is after the securing of the OLED to the circuit board.

Example 33: The method of Example 28, wherein the conductive adhesive is disposed between the OLED and the first conductor track.

Example 34: The method of Example 21, wherein the conductive adhesive further comprises at least one selected from the group consisting of copper, silver, gold, nickel, palladium, and platinum.

Example 35: The method of Example 21, wherein the conductive adhesive further comprises at least one nanomaterial selected from the group consisting of nanoparticles, nanowires, nanorods, nanosheets and nanoribbons.

Example 36: An electric vehicle, comprising:
a vehicle body, and
at least one safety light secured to the vehicle body,
wherein the at least one safety light comprises:
   an OLED disposed over and in electrical communication with a circuit board; and
a conductive adhesive securing the OLED to the circuit board,
wherein the OLED comprises:
   a cathode,
   an anode, and
   a light emitting layer disposed between the cathode and the anode,
wherein the circuit board comprises:
   a supporting substrate,
   a first conductor track disposed over a first surface of the supporting substrate, and
   a second conductor track disposed over a second surface of the supporting substrate,
wherein the conductive adhesive comprises:
   at least one carbon nanotube, and
   at least one adhesive matrix, and
wherein the electrical communication comprises:
   the cathode in electrical communication with a first terminal of the first conductor track, and
   the anode in electrical communication with a second terminal of the first conductor track.

Example 37: The electric vehicle of Example 36, wherein the at least one safety light comprises a turn signal disposed over a side of the vehicle body.

Example 38: The electric vehicle of Example 36, wherein the at least one safety light comprises a brake light disposed over a rear of the vehicle body.

Example 39: The electric vehicle of Example 36, wherein the at least one safety light comprises a running light adapted to remain illuminated during vehicle operation.

Example 40: The electric vehicle of Example 36, wherein the electric vehicle comprises an electric motorcycle.

Example 41: The electric vehicle of Example 36, wherein the conductive adhesive comprises a peel strength of from about 15 N/cm to about 195 N/cm.

While the present teachings have been illustrated with respect to one or more implementations, alterations and/or modifications may be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages may be added or existing structural components and/or processing stages may be removed or modified.

Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of three A, B and C. The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the illustrated embodiment.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A safety light, comprising:
an OLED disposed over and in electrical communication with a circuit board; and
a conductive adhesive securing the OLED to the circuit board,
wherein the OLED comprises:
a cathode,
an anode, and
a light emitting layer disposed between the cathode and the anode,
wherein the circuit board comprises:
a supporting substrate,
a first conductor track disposed over a first surface of the supporting substrate, and
a second conductor track disposed over a second surface of the supporting substrate,
wherein the conductive adhesive comprises:
at least one carbon nanotube, and
at least one adhesive matrix, and
wherein the electrical communication comprises:
the cathode in electrical communication with a first terminal of the first conductor track, and
the anode in electrical communication with a second terminal of the first conductor track.

2. The safety light of claim 1, wherein the at least one carbon nanotube comprises a plurality of carbon nanotubes.

3. The safety light of claim 1, wherein the conductive adhesive comprises 1-20% by weight of the at least one carbon nanotube.

4. The safety light of claim 1, wherein the conductive adhesive comprises a contact resistance of from about 0.1Ω to about 1.5Ω.

5. The safety light of claim 1, wherein the conductive adhesive comprises a peel strength of from about 15 N/cm to about 195 N/cm.

6. The safety light of claim 1, wherein the adhesive matrix is formed from a two-stage resin comprising a first resin and a second resin, and wherein the conductive adhesive is formed by dispersing the at least one carbon nanotube in the first resin to form a first mixture and subsequently forming a second mixture by adding the second resin to the first mixture.

7. The safety light of claim 1, wherein the conductive adhesive is disposed between the OLED and the first conductor track.

8. The safety light of claim 1, further comprising a battery disposed over and in electrical communication with the circuit board.

9. The safety light of claim 1, wherein the conductive adhesive further comprises graphene.

10. The safety light of claim 1, wherein the conductive adhesive is disposed with a thickness of from about 1 μm to about 500 μm.

11. A method for forming a safety light, comprising:
providing an OLED disposed over and in electrical communication with a circuit board; and
securing, with a conductive adhesive, the OLED to the circuit board,
wherein the OLED comprises:
a cathode,
an anode, and
a light emitting layer disposed between the cathode and the anode,
wherein the circuit board comprises:
a supporting substrate,
a first conductor track disposed over a first surface of the supporting substrate, and
a second conductor track disposed over a second surface of the supporting substrate,
wherein the conductive adhesive comprises:
at least one carbon nanotube, and
at least one adhesive matrix, and
wherein the electrical communication comprises:
the cathode in electrical communication with a first terminal of the first conductor track, and
the anode in electrical communication with a second terminal of the first conductor track.

12. The method of claim 11, further comprising preparing the conductive adhesive, wherein the preparing of the conductive adhesive comprises dispersing the at least one carbon nanotube in an adhesive matrix.

13. The method of claim 12, wherein the adhesive matrix comprises a 2-stage resin comprising a first resin and a second resin.

14. The method of claim 12, wherein the dispersing the at least one carbon nanotube in the adhesive matrix comprises dispersing the at least one carbon nanotube in the first resin to form a first mixture and subsequently forming a second mixture by adding the second resin to the first mixture.

15. The method of claim 14, further comprising coating the second mixture onto at least a portion of the first conductor track.

16. The method of claim 15, wherein the providing the OLED to the circuit board comprises pressing the OLED onto the at least the portion of the first conductor track coated with the second mixture.

17. The method of claim 16, wherein the securing comprises curing the second mixture.

18. The method of claim 11, wherein the conductive adhesive is disposed between the OLED and the first conductor track.

19. An electric vehicle, comprising:
a vehicle body, and
at least one safety light secured to the vehicle body,
wherein the at least one safety light comprises:
an OLED disposed over and in electrical communication with a circuit board; and
a conductive adhesive securing the OLED to the circuit board,
wherein the OLED comprises:
a cathode,
an anode, and
a light emitting layer disposed between the cathode and the anode,
wherein the circuit board comprises:
a supporting substrate,
a first conductor track disposed over a first surface of the supporting substrate, and
a second conductor track disposed over a second surface of the supporting substrate,
wherein the conductive adhesive comprises:
at least one carbon nanotube, and
at least one adhesive matrix, and
wherein the electrical communication comprises:
the cathode in electrical communication with a first terminal of the first conductor track, and
the anode in electrical communication with a second terminal of the first conductor track.

20. The electric vehicle of claim 19, wherein the electric vehicle comprises an electric motorcycle.
